(19) United States
(12) Patent Application Publication
(10) Pub. No.: US 2006/0127849 A1
(43) Pub. Date: Jun. 15, 2006

(54) Dental implant system

(76) Inventor: Ricardo Levisman, Buenos Aires (AR)

Correspondence Address: GREER, BURNS & CRAIN, 300 S WACKER DR, 25TH FLOOR, CHICAGO, IL, 60606, US

(21) Appl. No.: 11/012,931

(22) Filed: Dec. 15, 2004

(51) Int. Cl. A61C 8/00

(52) U.S. Cl. 433/173; 433/174

(57) ABSTRACT

A dental implant system comprising an implant body for installing into a drilled bore or a prepared recent post extraction socket in the bone of a patient, wherein the implant body has a frustoconical head having a nut-shaped outer contour for fit-receiving a wrench for installing the implant into a bone of a patient, and a frustoconical abutment that is end-to-end connected to the frustocnical head for fit-receiving a dental prosthesis.

### BACKGROUND OF THE INVENTION

1. Field of the Invention

The present invention relates to the medical field of prosthesis implantations and more specifically refers to a dental implant system that is simple, comprised of a reduced number of components, and easy as well as safe for implantation in the bone of a patient needed of the prosthesis or implant.

While the present specification makes a preferred reference to dental implants it must be clear that the teachings of the invention may be applied to any implant or prosthesis that is to be installed into a bone.

2. Description of the Prior Art

Prosthesis and implants are well known in the medical field, they are employed in connecting broken bones and replacing lost body parts. More precisely, in the odontology field, dental implants are being more and more employed to replace lost pieces, with the implants comprising basically an implant body that is fixed into the maxillary bone by screwing-in or nailing the implant into a bone hole such as the drilled bore or recent post extraction socket in the bone of a patient. Several techniques may be employed to permit correct osseointegration of the implant body into the bone and to wait for healing of the bone and gum. After the healing and integration period an abutment may be fixed into the implant body and a dental prosthesis or crown may be finally mounted and fixed, by screws or cement, onto the abutment and implant body. In some implantation techniques no healing period is waited for and the dental prosthesis and abutment are mounted and fixed to the implant body immediately after the same has been inserted and fixed into the bone.

Either nailed or screwed into the drilled bore or recent post extraction socket in the bone of a patient, the implant body has a head that should be firmly taken by a tool to bring the implant into the patient's mouth and inert the implant into the drilled bore or recent post extraction socket in the bone of a patient with the need of a slight or strong force. Generally, the post extraction socket is prepared before inserting the implant. When screwed into the bore, the implant body generally includes a nut-shaped formation at the head of the implant body, the nut-shaped region being provided to receive a screw driver or any other appropriate tool. For this purpose the heads usually are designed according to different configurations. These configurations also depend on the type of implant head as long as the head may require of an abutment to mount the dental prosthesis or the head may be already prepared to receive the dental prosthesis without the need of any other intermediate piece. In any event, the head generally is provided with a bore, blind or not, to receive either the abutment or the crown.

In those heads designed for receiving an abutment, the blind bore may be smooth to permit to rotate the abutment into the bore in order to obtain the best angular positioning of the abutment according to the teeth that are adjacent to the replacing implant. In this type of implant the nut configuration to receive a tool generally comprises a nut-shaped protrusion at the implant head, defined just around the blind bore. Since the outer contour of the implant body is generally cylindrical and the nut-shaped portion is comprised of a set of flat surfaces to form an octagon, for example, a step or sudden change of section is formed at the joint between the circular section of the implant body and the octagonal section of the nut protrusion. These steps impose an obstacle or a bar to the preparation and assembling of the crown or dental prosthesis that must be exactly designed to be fit-mounted onto the abutment and/or the implant head. Generally, undesired gaps remain between the crown and the implant generating spaces through which the saliva and other components enter with undesired effects on the correct mounting of the structure. If the crown is cemented onto the abutment and/or implant head, the cement generally becomes decay under the saliva and/or bacterial action.

Some implants lack of any nut protrusion or extension at the head to permit a better fit coupling of the crown and implant body and an easier and better design of the crown. However, a screw region must be provided to permit the use of a screwdriver or driving tool when inserting the implant into the drilled bore or recent post extraction socket in the bone of a patient. In these cases, a blind bore having a non-rotationally symmetrical inner contour is provided in the head. An example of this solution may be seen in Patent Application Publication No. US 2004/0096804 A1. The nut-shaped bore, however, has not shown to operate satisfactorily when a strong force is necessary for screwing the implant into the patient's bone. Generally, according to the inventor's experiences, the screw tool comes off the bore with unpredictable consequences to the patient.

It would be therefore convenient to have a simple but safe implant system having a few number of components with a crown and implant body designed to form fit-assembly with reduced or no possibilities of saliva or bacterial access into the assembly and excellent gripping for any screw or driving tool for installation purposes.

### SUMMARY OF THE INVENTION

It is therefore an object of the invention to provide a new implant system, preferably a dental implant construction that comprises one or two components for receiving a crown or dental prosthesis, with means for easily and firmly receiving and connecting an installation tool.

It is still another object of the present invention to provide a dental implant system comprising an implant body, and an abutment, for firmly mounting a dental prosthesis, wherein the prosthesis is tightly assembled onto the construction in order to prevent the entering into the assembly of saliva or any other matter.

It is a further object of the present invention to provide a dental implant system comprising an implant body for installing into a drilled bore or recent post extraction socket in the bone of a patient, wherein the implant body has a frustoconical head having a nut-shaped outer contour for fit-receiving a wrench for installing the implant into the bone of a patient.

It is a further object of the present invention to provide a dental implant system comprising an implant body having a root portion and a frustoconical head having a nut-shaped outer contour for fit-receiving a wrench for installing the implant into a bone of a patient.

It is still a further object of the present invention to provide a dental implant system comprising an implant body having a root portion and a frustoconical head having a nut-shaped outer contour for fit-receiving a wrench for installing the implant into a bone of a patient; an abutment for fixing into a blind bore in the head of the implant body, with the abutment having a smooth outer surface, and a dental prosthesis for fixing onto the abutment and the head of the implant, wherein the abutment and the head form together a frustoconical contour for form-fit attachment of the dental prosthesis.

It is a further object of the present invention to provide a dental implant system comprising an implant body having a root portion and a frustoconical head, and a wrench for installing the implant body into a bone of a patient, wherein the frustoconical head has a nut-shaped outer contour for fit-receiving said wrench.

It is a further object of the present invention to provide a dental implant system comprising an implant body having a root portion and a frustoconical head; an abutment for fixing into a blind bore in the head of the implant body, with the abutment having a smooth outer surface; a dental prosthesis for fixing onto the abutment and head of the implant, and a wrench for installing the implant body into a bone of a patient, wherein the frustoconical head has a nut-shaped outer contour for fit-receiving said wrench and wherein the abutment and the head form together a frustoconical contour for form fit-attachment of the crown.

It is a further object of the present invention to provide a dental implant system comprising an implant body having a frustoconical head having a nut-shaped outer contour and including a blind bore, and a removable gingival former for temporarily fixing into the blind bore for guiding the healing of the gum or preserving the interdental papilla, the former having a frustoconical nut-shaped inner contour to match the frustoconical nut-shaped outer contour of the head of the implant body.

It is a further object of the present invention to provide a dental implant system comprising an implant body having a root portion and a head having a frustoconical profile with a nut-shaped outer contour for fit-receiving a wrench for installing the implant into a bone of a patient; an abutment for fixing into a blind bore in the head of the implant body and for end-to-end coupling to the head, the abutment having a frustoconical smooth outer surface continuing the frustoconical profile of the head, and a dental prosthesis having a generally frustoconical cavity for fixing onto the abutment and the head of the implant, wherein the abutment and the head form together a frustoconical contour for form-fit attachment of the dental prosthesis and the prosthesis cavity has a frustoconical nut-shaped inner contour to match the frustoconical nut-shaped outer contour of the head of the implant body.

The above and other objects, features and advantages of this invention will be better understood when taken in connection with the accompanying drawings and description.

### BRIEF DESCRIPTION OF THE DRAWINGS

The present invention is illustrated by way of example in the following drawings wherein:

FIG. 1 shows an elevational side view of an implant body according to the present invention.

FIG. 2 shows a top plan view of the implant body of FIG. 1.

FIG. 3 shows a perspective view of the head of the implant body and a wrench for use in the implant system according to the invention.

FIG. 4 shows an elevational partial cross-sectional view of an implant body installed into a bone of a patient and a gingival former or cap mounted into the blind bore for a healing period.

FIG. 5 shows an elevational side view of a straight abutment for mounting onto the implant body of FIG. 1.

FIG. 6 shows an elevational side view of an angled abutment for mounting onto the implant body of FIG. 1.

FIG. 7 shows an elevational partial cross-sectional view of an implant body installed into a bone of a patient and an abutment fixed into the blind bore of the implant body, with a crown or dental prosthesis fixed to the abutment and implant body.

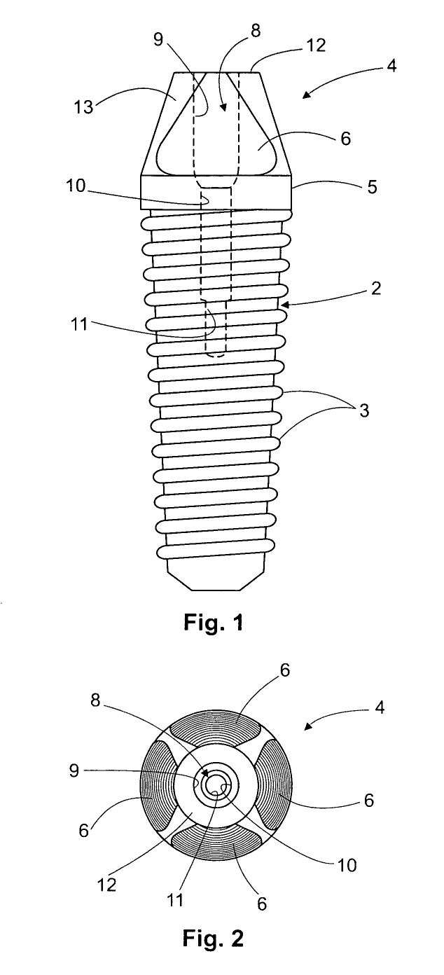

### DESCRIPTION OF THE PREFERRED EMBODIMENTS

Now referring in detail to the invention, the dental implant system comprises an implant body 1 with root portion 2 generally of a conical or tapered shape including a plurality of threads 3 and a head portion or head 4 having a frustoconical profile. The implant body with its corresponding portions is made preferably of a bio-compatible material, such as a metal, more preferably titanium and most preferably titanium chemically treated, for example by an osseo conductive substance, to have an outer surface for promoting the osseous integration of the implant into the patient's bone. Root portion 2 and head portion 4 are preferably separated by a collar portion 5, preferably a cylindrical body portion, free of threads. Threads 3 may be of any convenient and/or desired design but, preferably, they are of a rounded profile.

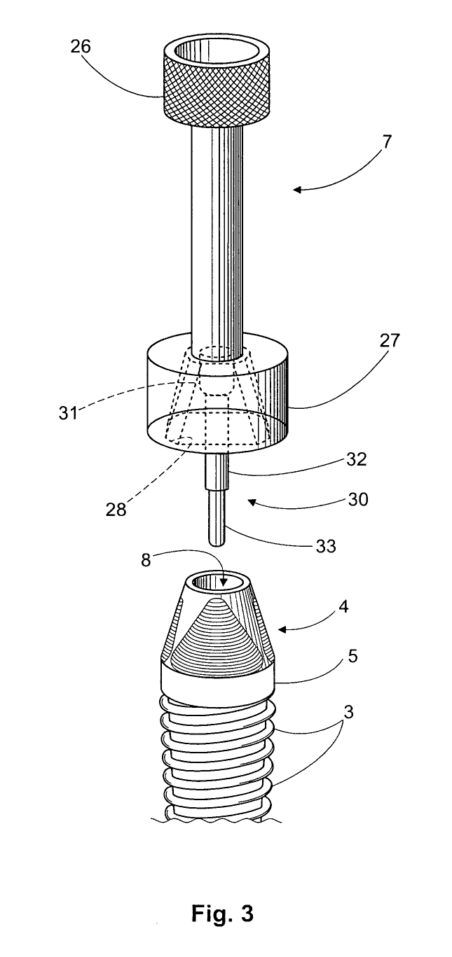

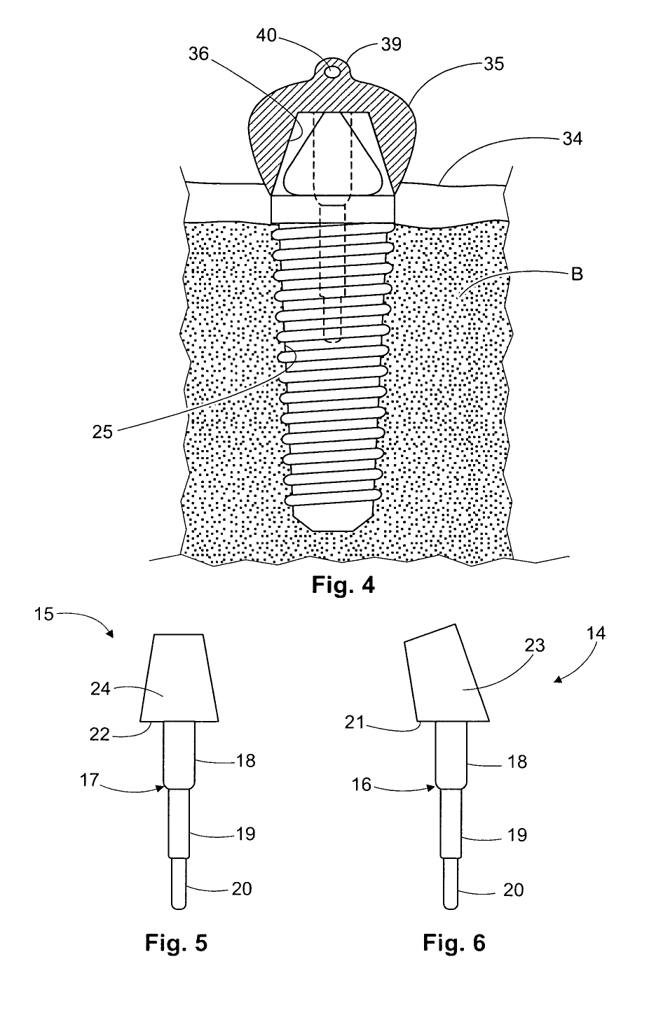

According to the teachings of the invention, head portion 4 has an anti-rotational design, preferably the head is provided with a nut-shaped outer contour comprised of several, preferably four or six flat or concave faces 6. Only four faces 6 are shown in the drawings for clarity purposes by any reasonable number of flat or concave faces may be included according to the principles of the invention. The “nut” design of head 4 is provided for fit-receiving a wrench 7, better illustrated in FIG. 3, for installing the implant into a bone “B” of a patient, FIG. 4.

In any event the expression nut-shaped contour must be interpreted and understood as anti-rotational contours and not necessarily as a nut shape. The anti-rotational design incorporated into the frustoconical shape of the head portion makes the implant body to have no steps, as all the implants with anti-rotational outer means, at the head portion and proximal end of the implant but providing at the same time an excellent fit characteristic at the head for mounting the crown or dental prosthesis. The frustoconical contour provides the well known morse taper effect for improving the retention of the crown onto the implant head. This has not been achieved by other implants that have included a nut projection at the proximal end of the implant thus defining a step between the nut-faces and the cylindrical body.

More particularly, frustoconical head portion 4 is provided with a smooth conical surface 13 and anti-rotational surfaces 6 are defined in such a manner that no steps or sudden surface changes are formed in the head portion, particularly no steps between the frustoconical head portion and the root portion 2 or collar 5. Thus, the frustoconical head smoothly merges into a cylindrical collar 5 or, if collar 5 is not provided, into the root portion of the implant defining a merging section without any step. The dental prosthesis, to which reference will be made below, will extend onto, and cover, the merging section. At the opposite end, head 4 ends in an edge 12, or upper annular face, which edge may be rounded or formed into a smooth collar for preventing the patient's tongue from any damage against any potential sharp edge of the implant during the installation.

The implant head 4 is provided with a bore, preferably a blind bore stepped with at least three complementary diameters forming a first bore portion 9, a second bore portion 10 and a third bore portion 11. A lower or higher number of bore portions may be provided within the scope of the invention.

The implant system also comprises an abutment, either a straight abutment 14, shown in FIG. 5, or an angled abutment 15, shown in FIG. 6. Both abutments include a stem 16, 17, for fixing into bore 8 of head portion 4. Stem 16, 17 of the abutment is stepped like blind bore 8 of the head, with stepped sections 18, 19, 20 and the sections diameters are complementary or correspond to the steps 9, 10, 11 of bore 8. Generally, blind bore 8 is a cylindrical bore having a smooth inner surface for receiving cylindrical stem 16, 17, of abutment 14, 15, wherein the stepped stem is positioned into the stepped blind bore, adjusted into the desired position and cemented into the blind bore. Since bore 8 and stems 16, 17 have respective circular sections, the stem may be rotated into bore 8 to place the abutment, particularly the angled abutment, at the desired position.

With stem 16, 17 inserted into bore 8, a bottom end 21, 22 of a frustoconical abutment head 23, 24, is positioned against edge 12 of head portion 4 in an end-to-end relationship. The abutment, as indicated above, has a conical or frustoconical shape with a smooth outer surface that continues the frustoconical profile of head 4 in order to form together a continuous contour, with no steps or gaps between head 4 and abutment head 23, 24. This forms a continuous seat for mounting a dental prosthesis as disclosed below. 4.

In order to install the inventive implant in a patient, the implant body 1 is taken, for example by means of a clip, and inserted into a bore 25 of bone “B”. Bore 25 may be a drilled bore or a recent pos-extraction socket. Once the implant body is inserted into bone “B”, a tool or wrench 7, shown in FIG. 3, is coupled to head 4. Wrench 7 has a design for fit-coupling onto said head of the implant body. Preferably, wrench 7 has a handle 26 and an operating head 27 having a frustoconical socket 28 with polygon contour therein for fit-attachment onto the nut-shaped or anti-rotational outer contour of implant body head 4. In order to easily guide the coupling of socket 28 onto head 4, a pin 30 axially extends out of the frustoconical socket for entering into the blind bore of the implant head for guiding and retaining the socket exactly onto the implant body head. Pin 30 is preferably stepped with three diameter sections 31, 32, 33, in order to accommodate to the three sections 9, 10, 11 of blind bore 8 in head 4. Tool 7 is manually rotated by the fingers of a hand and implant body 2 is threaded into bone socket 25. Threads 3, such as the ones of inventor's U.S. Pat. No. 6,315,564, will exert a pressure against the bone enough to provide a strong retention of body 2 into bore 25 and to promote the bone growth around the implant body and the threads.

The inventive implant system is of the emerged-type wherein at least part of head 4 remains above gum 34 of the patient when installed into the bone. Once the implant body is installed into bone socket 25 a removable gingival former 35, shown in cross-section in FIG. 4, is placed onto head 4 of the implant body for guiding the healing of the gum or for preserving the interdental papilla. Former 35 is preferably made of plastics and has an inner cavity 36 with a frustoconical anti-rotational or nut-shaped contour to match the frustoconical anti-rotational or nut-shaped outer contour of the head of the implant body. Former 35 may be also provided with a stem similar to that one of 30 of tool 7 or 16, 17 of abutment 14, 15 in order to fix into bore 8 of the implant body. In any event, since the use of former 35 is temporary, the coupling of former 35 onto head 4 must be strong enough to prevent loosing of same during the use in the patient's mouth but not so strong in order to that the former is easily removed by the doctor.

In addition, former 36 is preferably provided with a ring 39 with an orifice 40 for retaining former and implant body static in a desired place relative to an adjacent implant. When two adjacent implants are installed in two adjacent bores, or a big bore, in the bone, it is frequent that at least one of the implants does not result entirely fixed during healing and the implant is allowed to move. Under these circumstances, a wire, not shown, is passed through orifice 40 of both adjacent implants and an adhesive, for instance an acrylic adhesive, is employed to fix the wire in both formers 36 to keep both adjacent implants relative fix to each other.

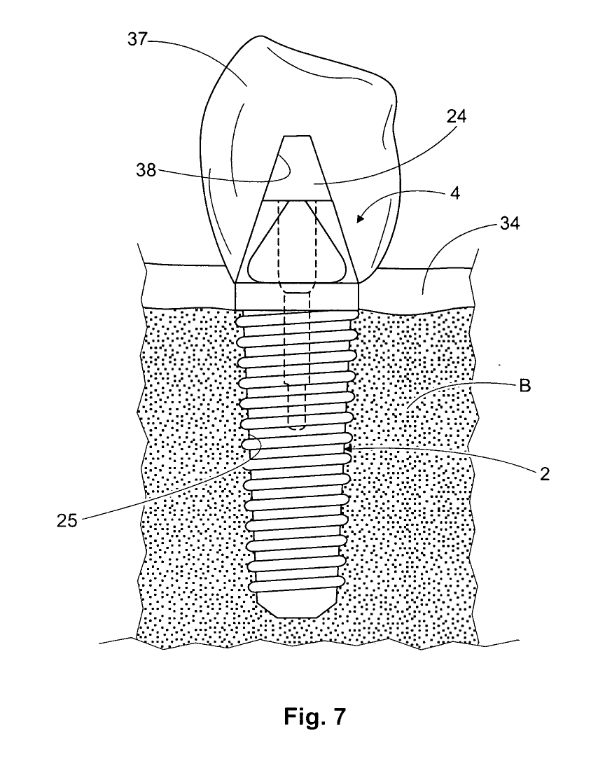

Once the former is removed a dental prosthesis 37 is mounted onto head 4 and abutment 24. Dental prosthesis 37 has a generally frustoconical cavity 38 for fixing onto the abutment and the head of the implant, wherein the abutment and the head form together a frustoconical contour for form-fit attachment of the dental prosthesis and the prosthesis cavity has a frustoconical anti-rotational or nut-shaped inner contour to match the frustoconical anti-rotational or nut-shaped outer contour of head 4 of the implant body. Preferably, the dental prosthesis is cemented onto the abutment and head just above merging section 5, as shown in FIG. 7.

While preferred embodiments of the present invention have been illustrated and described, it will be obvious to those skilled in the art that various changes and modifications may be made therein without departing from the scope of the invention as defined in the appended claims.

I claim:

1. A dental implant system comprising:
an implant body having a root portion and a head having a frustoconical profile with a nut-shaped outer contour for fit-receiving a wrench for installing the implant into a bone of a patient;
an abutment for fixing into a blind bore in the head of the implant body and for end-to-end coupling to the head, the abutment having a frustoconical smooth outer surface continuing the frustoconical profile of the head, and
a dental prosthesis having a generally frustoconical cavity for fixing onto the abutment and the head of the implant, wherein the abutment and the head form together a frustoconical contour for form-fit attachment of the dental prosthesis and the prosthesis cavity has a frustoconical nut-shaped inner contour to match the frustoconical nut-shaped outer contour of the head of the implant body.

2. The implant system of claim 1, wherein the frustoconical contour formed by the abutment and the head is a continuous contour, free of any step.

3. The implant system of claim 1, wherein the blind bore is a cylindrical bore having a smooth inner surface for receiving a cylindrical stem of the abutment, wherein the stem is positioned into the blind bore, adjusted into the desired position and cemented into the blind bore.

4. The implant system of claim 1, wherein the implant is of the emerged-type wherein at least part of the head remains above the gum of the patient when installed into the bone.

5. The implant system of claim 1, wherein the frustoconical head smoothly merges into a cylindrical body portion of the implant defining a merging section without any step, wherein the dental prosthesis extends onto, and covers, the merging section.

6. The implant of claim 5, wherein the dental prosthesis is cemented onto the abutment and head.

7. The implant system of claim 1, wherein the abutment is an angular abutment.

8. The implant system of claim 3, wherein the blind bore of the head and the stem of the abutment are stepped with at least three complementary diameters.

9. The implant system of claim 1, further comprising a removable gingival former for temporarily fixing into the blind bore for guiding the healing of the gum or for preserving the interdental papilla, the former having an inner cavity with a frustoconical nut-shaped contour to match the frustoconical nut-shaped outer contour of the head of the implant body.

10. A dental implant system comprising:
an implant body having a root portion and a head having a frustoconical profile with a nut-shaped outer contour;
an abutment for fixing into a blind bore in the head of the implant body and for end-to-end coupling to the head, the abutment having a frustoconical smooth outer surface continuing the frustoconical profile of the head;
a dental prosthesis having a generally frustoconical cavity for fixing onto the abutment and the head of the implant, wherein the abutment and the head form together a frustoconical contour for form-fit attachment of the dental prosthesis and the prosthesis cavity has a frustoconical nut-shaped inner contour to match the frustoconical nut-shaped outer contour of the head of the implant body, and
a wrench for installing the implant body into a bone of a patient, wherein the wrench has a design for fit-coupling onto said head of the implant body.

11. The implant system of claim 10, wherein the wrench has a handle and an operating head having a frustoconical socket with polygon contour therein for fit-attachment onto the nut-shaped outer contour of the implant body head.

12. The implant system of claim 11, wherein the operating head of the wrench has a pin axially extending out of the frustoconical socket for entering into the blind bore of the implant head for guiding and retaining the socket exactly onto the implant body head.

13. The implant system of claim 12, wherein the blind bore of the head and the pin axially extending out of the frustoconical socket are stepped with at least three complementary diameters.

14. The implant system of claim 10, further comprising a removable gingival former for temporarily fixing into the blind bore for guiding the healing of the gum or for preserving the interdental papilla, the former having a frustoconical nut-shaped inner contour to match the frustoconical nut-shaped outer contour of the head of the implant body.

15. The implant system of claim 10, wherein the frustoconical contour formed by the abutment and the head is a continuous contour, free of any step.

16. The implant system of claim 10, wherein the blind bore is a cylindrical bore having a smooth inner surface for receiving a cylindrical stem of the abutment, wherein the stem is positioned into the blind bore, adjusted into the desired position and cemented into the blind bore.

17. The implant system of claim 16, wherein the blind bore of the head and the stem of the abutment are stepped with at least three complementary diameters.

18. The implant system of claim 10, wherein the implant is of the emerged-type wherein at least part of the head remains above the gum of the patient when installed into the bone.

19. The implant system of claim 10, wherein the frustoconical head smoothly merges into a cylindrical body portion of the implant defining a merging section without any step, wherein the dental prosthesis extends onto, and covers, the merging section.

20. The implant of claim 19, wherein the dental prosthesis is cemented onto the abutment and head.

21. The implant system of claim 10, wherein the abutment is an angular abutment.

22. The implant system of claim 10, wherein the blind bore of the head and the stem of the abutment are stepped with at least three complementary diameters.

23. The implant system of claim 9, wherein the gingival former includes a ring at a top thereof for fixing a support wire to connect to an adjacent former located in an adjacent implant.

24. The implant system of claim 14, wherein the gingival former includes a ring at a top thereof for fixing a support wire to connect to an adjacent former located in an adjacent implant.
